(19) United States
(12) Patent Application Publication
(10) Pub. No.: US 2015/0212984 A1
(43) Pub. Date: Jul. 30, 2015

(54) SOCIAL MEDIA AND EMAIL MESSAGE AGGREGATOR

(71) Applicant: Robert Bowden, Little Silver, NJ (US)

(72) Inventor: Robert Bowden, Little Silver, NJ (US)

(21) Appl. No.: 14/163,282

(22) Filed: Jan. 24, 2014

(51) Int. Cl. G06F 17/22; G06F 17/30

(52) U.S. Cl. CPC G06F 17/2247; G06F 17/30867

(57) ABSTRACT

A system for providing an application to view and access messages from different platforms is provided. The system receives information identifying a user's web based messaging accounts such as e-mail, social media, blogs, and message boards. The system then accesses these accounts and retrieves any messages. The messages are displayed in a message feed portal along with information identifying the source platform of the message. A user is able to click on each message to view the full message and respond thereto. A user is thus able to view all of their electronic messages from different platforms in one place.

### FIELD OF THE INVENTION

The present invention generally relates to integrating message feeds from multiple sources. Specifically, this invention relates to systems and methods for providing a centralized application for viewing and accessing message feeds from multiple sources including e-mail, social media, message boards, blogs, and mobile devices.

### BACKGROUND

As our world becomes more inundated with web-based systems and smart mobile devices for communicating, people can quickly become overwhelmed. There are presently numerous sources of web-based communications systems that people are constantly using, such as e-mail, text messages, social media websites, blogs, photo/file sharing sites, etc. Social Networking and Microblogging sites such as Facebook®, Instagram®, Flikr®, Tumblr®, Twitter®, LinkedIn®, Google+™, etc. provide users with alternative ways to communicate and share information. One of the most frustrating aspects of these systems however involves logging in and out of these sites in order to access messages and keep up with conversations. Furthermore, with today's emphasis on security, a person is often required to enter various security credentials including screen names, passwords, security keys, or answer security questions each time they attempt to access a site containing personal messages or other information sent to them.

Shuttling back and forth between these different sites respond to messages and participate in conversations can be frustrating. There is therefore a need for a single centralized application that displays all of a user's messages from different sources and provides easy access to email, text messages, social media postings, and other messages regardless of their source. These and other features and advantages of the present invention will be explained and will become obvious to one skilled in the art through the summary of the invention that follows.

### SUMMARY OF THE INVENTION

Accordingly, it is an aspect of the present invention to provide a system and method for providing a centralized application viewing and accessing messages from different platforms.

According to an embodiment of the present invention, a system provides an application for viewing and accessing messages from different platforms, such as email, text, social networking, blogs, and other message sources. The system comprises a processor, a non-transitory computer readable memory in communication with said processor, and an aggregator module. The aggregator module includes computer-executable code stored in memory. The processor, memory, and aggregator module are operably connected and configured to generate an application for displaying a user's messages from a variety of different platforms.

According to an embodiment of the present invention, the aggregator module is configured to receive information from a user to identify the user's web-based messaging accounts. These accounts may include one or more e-mail accounts, mobile phone accounts, smart device accounts, social media accounts, blog accounts, or other message or file sharing accounts. The aggregator module is further configured to receive account access information from a user in order to access the identified messaging accounts. Once this information is provided by the user, the aggregator module can access each of the identified messaging accounts and acquires the messages. These messages are then displayed in an application for a user to view and access.

A user may respond to any of the displayed messages by selecting or clicking it. A message reply may be generated in the portal for distribution/posting in the native platform where the message originated. Alternatively, selecting a message displayed in the portal may take a user to the native platform in which the message originated. In that case, the aggregator will provide a link to return to the portal from the native platform. The user is thus able to enter a response in the native platform and return to the list of message feeds displayed in the portal. The aggregator module periodically updates the list of messages by accessing the user's messaging accounts and retrieving any new messages.

According to an embodiment of the present invention, a system for providing a social aggregator includes: a processor; a non-transitory, computer readable memory in communication with said processor; an aggregator module comprising computer-executable code stored in said memory, wherein said aggregator module, said processor, and said memory are communicatively connected, and said aggregator module is configured to: receive information identifying said user's web-based messaging accounts; receive login information from said user for each of said accounts; access said accounts and retrieve one or more of messages from said accounts; display said one or more messages in a web-based message portal, wherein a user is able to respond to any of said messages by selecting it in the message portal, and wherein said messages are periodically updated.

According to an embodiment of the present invention, the messaging accounts comprise e-mail, social media, blog, microblog, file sharing, message board, text message, instant message, live chat, VOIP, videoconferencing, and mobile device accounts.

According to an embodiment of the present invention, the system further includes a social media setup module configured to generate a social media setup web page in which a user can identify and setup one or more social media accounts from which messages can be retrieved and displayed in said message feed portal.

According to an embodiment of the present invention, the system further includes an email setup module configured to generate an email setup web page in which a user can identify and setup email accounts from which email messages can be retrieved and displayed in said message feed portal.

According to an embodiment of the present invention, the messages comprise emails, notifications, conversation threads, postings, instant messages, text messages, or any other electronic communications.

According to an embodiment of the present invention, the aggregator module is integrated with a third-party platform's API.

According to an embodiment of the present invention, the system further includes a message portal module configured to generate said message feed portal.

According to an embodiment of the present invention, the one or more messages are link objects.

According to an embodiment of the present invention, the act of clicking on one of said messages takes a user to the native platform from which the message originated.

According to an embodiment of the present invention, the system further includes an admin module configured to generate an admin portal for performing various administrative functions.

According to an embodiment of the present invention, the administrative functions include: adding new admin users, removing admin users, viewing registered users, viewing user account details, blocking access to the system, exporting messages, view incoming/outgoing messages, review inbound contact requests, and reviewing contact history.

According to an embodiment of the present invention, the system further includes a feedback module configured to collect user feedback and ratings about the web-based message portal system.

According to an embodiment of the present invention, a computer implemented method for providing a social aggregator includes the steps of: receiving information identifying a user's web-based messaging accounts; receiving login information for said accounts; accessing said accounts; retrieving one or more messages from said accounts; displaying said messages in a web-based message portal, wherein a user is able to respond to any of said messages by selected it in said message portal, and wherein, said messages are periodically updated.

According to an embodiment of the present invention, the web-based messaging accounts include e-mail, social media, blog, microblog, file sharing, message board, text message, instant message, live chat, VOIP, videoconferencing, and mobile device accounts.

According to an embodiment of the present invention, the messages comprise emails, notifications, conversation threads, postings, instant messages, text messages, or any other electronic communications.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3 illustrates a network schematic of a system, in accordance with an embodiment of the present invention;

FIG. 4 illustrates a schematic of a message aggregator system, in accordance with an embodiment of the present invention; and

FIG. 5 is a process flow of an exemplary method in accordance with embodiments of the present invention.

### DETAILED SPECIFICATION

The present invention generally relates to computer and web-based messaging services. Specifically, this invention relates to systems and methods for aggregating messages from different platforms and displaying them in a single application for viewing and access.

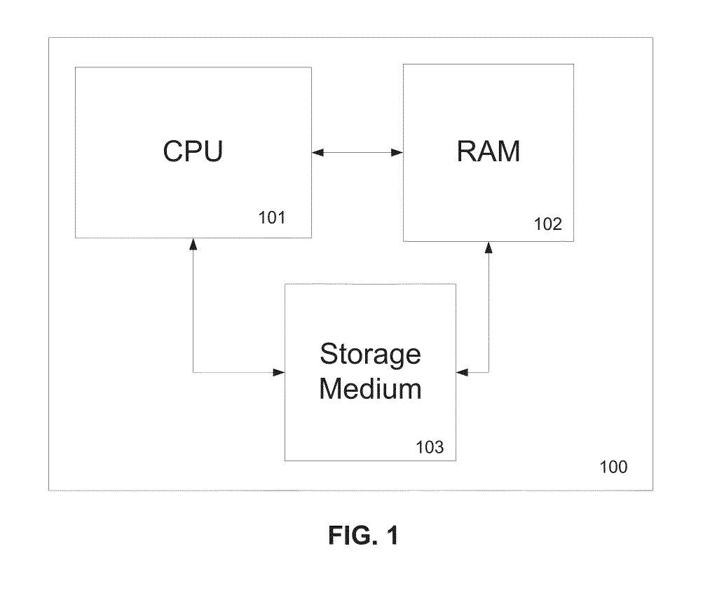

According to an embodiment of the present invention, the systems and methods are accomplished through the use of one or more computing devices. As shown in FIG. 1, one of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

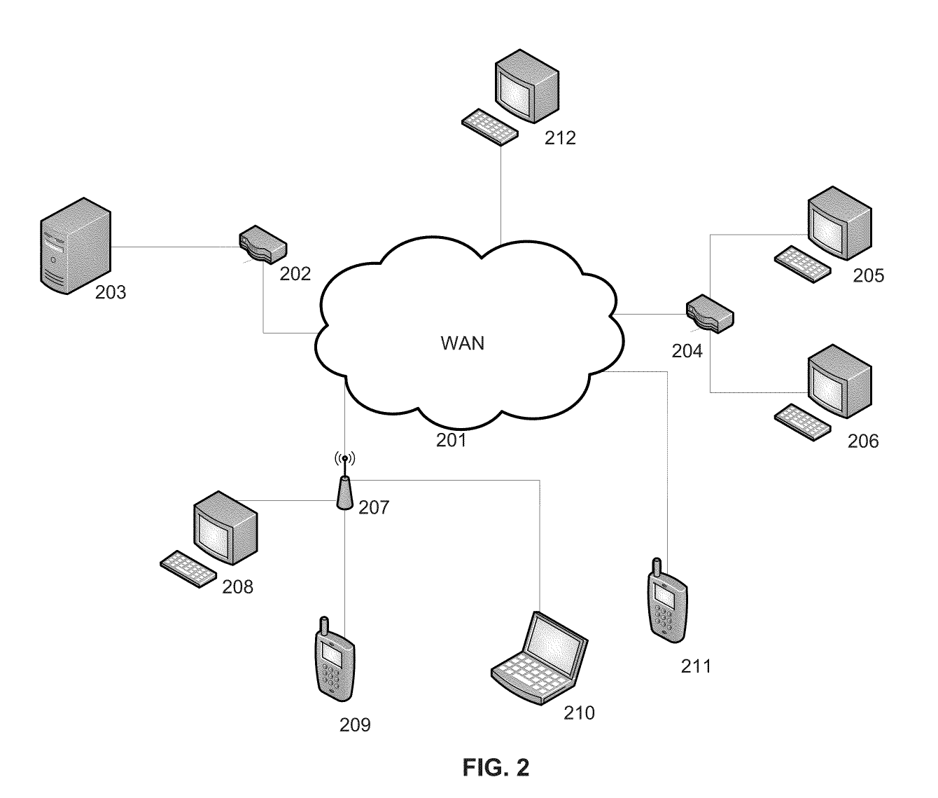

Referring to FIG. 2, a schematic overview of a system in accordance with an embodiment of the present invention is shown. The system is comprised of one or more application servers 203 for electronically storing information used by the system. Applications in the application server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

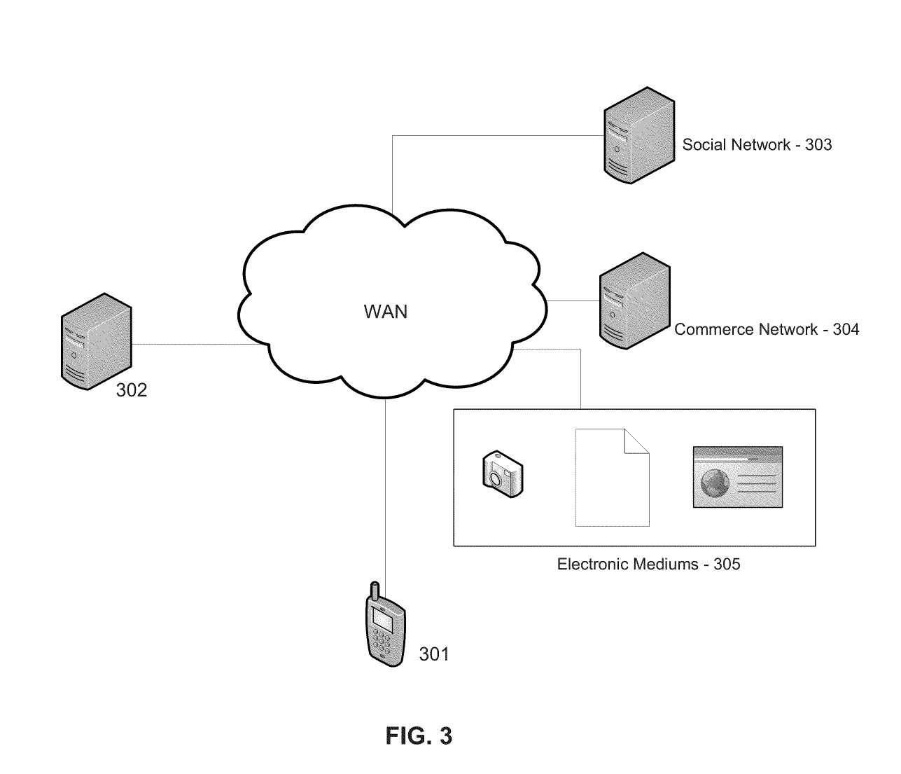

Turning now to FIG. 3, a continued schematic overview of a system in accordance with an embodiment of the present invention is shown. In FIG. 3, the system is shown as it may interact with users and other third party networks or APIs. For instance, a user of a mobile device 301 may be able to connect to application server 302. Application server 302 may be able to enhance or otherwise provide additional services to the user by requesting and receiving information from one or more of a social network 303, an e-commerce API/website or other third party commerce system 304, one or more direct links or other directly provided data in the form of an electronic medium 305 (e.g., product photo, product brochure, service description, uniform resource locator (URL)) or any combination thereof. One of ordinary skill in the art would appreciate how accessing one or more third-party systems could augment the ability of the system described herein, and embodiments of the present invention are contemplated for use with any third-party system.

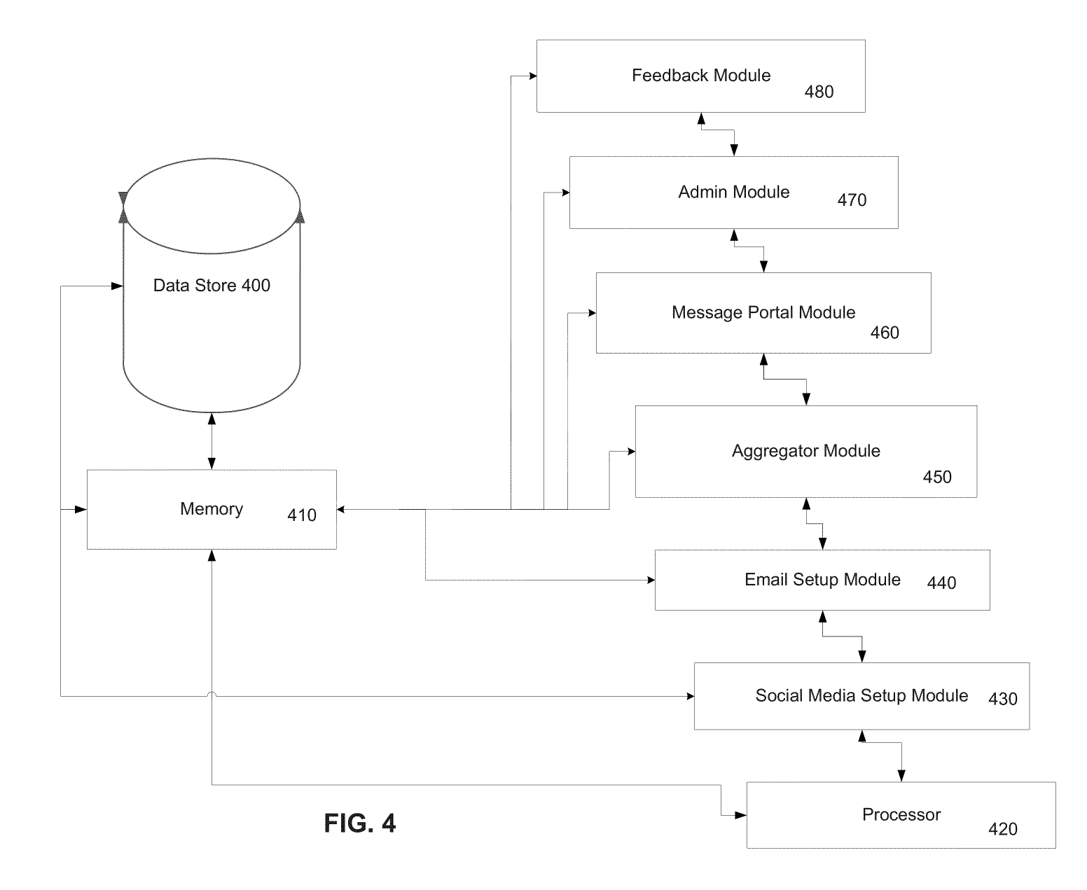

Turning to FIG. 4, according to an embodiment of the present invention, a system for providing an application for viewing and accessing messages from different platforms is comprised of a data store 400, a memory 410, a processor 420, a social media setup module 430, an email setup module 440, a message portal module 450, an aggregator module 460, an admin module 470, and a feedback module 480. In alternate embodiments, the system may have additional or fewer components. One of ordinary skill in the art would appreciate that the system may be operable with a number of optional components, and embodiments of the present invention are contemplated for use with any such optional component.

The social media setup module 430 is configured to generate a graphical user interface (GUI) in which a user can identify and setup one or more social media accounts from which messages/notifications can be retrieved. GUIs may include, but are not limited to, proprietary interfaces for use with mobile devices or other computing devices or platform agnostic display interfaces, such as webpages or other interactive forms (e.g., HTML, HTML5, JavaScript, Flash) In a preferred embodiment, the GUI is integrated with a plurality of social media APIs. When a user selects a social media site by clicking it the user is taken to the social media site where they can enter their login credentials. In other embodiments, the system may be configured to utilize single sign-on (SSO) or other access control means and methods to allow users to concurrently access more than one restricted site with a reduced number of login requirements. One of ordinary skill in the art would appreciate that there are numerous methods for providing SSO or other access control means, and embodiments of the present invention are contemplated for use with any SSO or other access control means.

According to an embodiment of the present invention, the system may record the user's login credentials, or the user may be given an option to save their login credentials with the system, so that the system may utilize this login information to access the account and retrieve messages. In a preferred embodiment of the present invention, once the login information is saved with the system, the social media setup module displays a “next” button, which indicates that the social media account was successfully linked to the system, i.e. messages from the social media account(s) will be retrieved and displayed in the message portal. One of ordinary skill in the art would appreciate that a message portal, or any portal as used herein, refers to a GUI related to a specific portion of an application or web interface and may be presented in any number of manners or means, depending on platform and device type. Clicking the “next” button takes the user to a GUI to set up their e-mail accounts.

The email setup module 440 is configured to generate an email setup GUI in which a user can identify and setup their email accounts from which e-mail messages may be retrieved. The e-mail setup GUI may be integrated with any POP3 e-mail program API. Moreover, a user is able to link multiple POP3 or other types of email accounts. When user clicks a “done” button the email accounts are linked successfully, i.e. messages from the e-mail account(s) can be retrieved and displayed in the message portal. The user is then taken to a “Review and Confirm” GUI in which a user is able to review and confirm the e-mail account settings and confirm that they wish to add the account. A “set another” button allows a user to link another POP3 email account.

The aggregator module 450 is configured to retrieve a user's messages, including notifications, conversation threads, postings, instant messages, text messages, and other electronic communications, from a user's e-mail, social media, and other messaging accounts (i.e. native third-party platforms). This is may be accomplished through integration with the native platform's API. The terms “native platform”, “third-party platform”, and “native third-party platform” shall be regarded as equivalent terms throughout this application.

According to an embodiment of the present invention, the aggregator module is configured to receive information from a user identifying the user's web-based messaging accounts. These accounts may include: e-mail accounts, social networking accounts, professional networking accounts, blogging accounts, microblogging accounts, message board accounts, text messaging accounts, instant messaging accounts, photo/file sharing accounts, and the like. The information received from the user may include account access information such as login information for each of the referenced accounts. Once the account access information is received, the aggregator module is configured to access each account and retrieve the user's messages. The aggregator module may further be configured to analyze, process, and communicate information from and between the third-party platforms to assist in retrieving the user's messages. In a preferred embodiment, the accessibility to these third-party platforms may be by way of API or other programmatic communications means.

The aggregator module is further configured to periodically update the message feeds displayed in the portal. In certain embodiments, the aggregator maintains accesses to the user's messaging accounts and retrieves any new messages. As discussed above, any new messages are preferably displayed at the top of a list of messages in the message feed portal. However, this is not required.

The message portal module 460 is configured to generate a message feed portal for displaying messages from a user's e-mail and social media platforms. Alternatively, the message portal module may utilize a pre-existing application to display the acquired messages. One of ordinary skill will appreciate that the message portal may be accessed by any type of networked or standalone computing device including any stationary or mobile computing device. Furthermore, resources of the portal may be available offline (i.e. when disconnected from a network), although some resources may be unavailable.

According to a preferred embodiment, the message feed page is the main landing page for users. The terms “feed page”, “message page”, “message feed page”, “feed application”, “message application”, “message feed application”, “feed portal”, “message portal”, and “message feed portal” shall be regarded as equivalent or substitutable terms throughout this application. The message portal will list all messages, such as activity notifications, for linked social media and email accounts of the user. Incoming notifications will push down old notifications and may glow for some period of time. Notifications are displayed one line at a time and may be summarized or truncated to fit on a line.

In a preferred embodiment of the invention, the messages listed in the message portals are link objects that perform an action upon being clicked or selected. The action performed may be to open the full message in a separate window along with a response field. Alternatively, the action may be to take the user to the native platform in which the message was created. The user can then reply to the message using the native platform's functionality. In the event a user is taken to the native platform upon clicking a message, the system will provide a return link configured to take the user back to the message feed portal.

The messages listed in the message portal may be displayed in any order, but are preferably displayed in order of most recent message. That is, newer messages appear at the top of the list and earlier messages are bumped down the list as new messages arrive. In addition, newer messages may be identified in some way, such as by intermittent flashing, glowing, highlighting, blinking, color, contrast, font, style, size, or any appropriate means so as to alert the user that the message is new. In addition, unread messages may be displayed in a manner so as to differentiate them from messages already read. A person of ordinary skill in the art will recognize that there are numerous ways to display messages in such a way as to identify their status.

As mentioned above, messages may be displayed in any order. For example, messages may be organized according to their source. Alternatively, messages may be displayed according to their perceived importance, or based on the sender/author of the message. Messages may also be displayed according to date/time, subject, or size. One of ordinary skill in the art will appreciate that messages may be displayed or ranked in any number of ways, and according to many different criteria. Furthermore, there may be a default setting for displaying messages which can be altered by the user at their discretion.

According to an embodiment of the present invention, the messages may be condensed to fit in an apportioned area of the message feed portal. For example, each message may be allotted one line in the portal, so that only a portion of the message may be displayed. The aggregator may condense the message in such a manner as to provide a clear idea of the subject of the message, or may simply truncate the message to fit in the apportioned area. One of ordinary skill in the art will appreciate that any portion of a message, including the entire message, may be displayed based on available space, or based on user preference.

If a message contains information other than text such as documents, photos, audio, video, animation, or some other file, the aggregator may display a representative icon, thumbnail, or graphic to indicate the presence of an attached or embedded file with the message. In addition, the messages may include an indicator identifying the native platform and/or sender/author of the message. For example, an icon or symbol may appear in proximity to the message which identifies the platform as Facebook® and the sender/author as John Doe.

According to an embodiment of the invention a user may click on a message in the message portal to access and respond to it. Clicking a message may display the full message in a window along with a response field. Alternatively, clicking a message may take the user to the native platform in which the message originated. The user may then utilize the functionality of the native platform to respond to the message. In this embodiment, the aggregator module is also configured to provide a link back to the message portal from the native platform.

According to an embodiment of the present invention, the message portal includes functionality that allows a user to add or remove message accounts linked to the portal at any time. For example, a user who wishes to add a Flickr® account to the portal can easily do so by providing identifying information about the account, such as URL, along with the user's login information.

The admin module 470 is configured to generate a login portal which includes “login” and “cancel” buttons and a “forgot password” link. Login portals are well known and include the usual login/logout functionality. In addition, the Admin module is configured to provide an Admin Users Controller. The Controller gives the admin user the ability to add, edit, and remove admin level users.

The admin module may be further configured to generate an admin portal for performing various administrative functions, such as adding new admin users. The admin module may generate a new user page if an admin user tries to add a new admin user. The new user page may include one or more of the following fields: First Name, Last Name, Email Address, Password and Confirm Password. In addition, the new user page may include save and cancel buttons.

The admin module may be further configured to provide an option for viewing a list of registered users. In addition, the admin module may provide a “View Account Detail” function. This function gives the admin user the ability to view the profile details for any user profile. An edit function allows an admin user to edit files such as images, audio, and video saved on the system. Similarly, the admin module includes a remove function that allows an admin user to remove files from the system. A “chicken switch” may be provided by the admin module prior to the removal/deletion of any content.

The admin module further includes a means of blocking a user from logging in using their login credentials. This function may be used in the event a user is banned from using the system due to inappropriate conduct. The admin module is also configured to enable an admin user to export the entire list of messages to a comma separated values format.

The admin module also in includes an Admin Outbound Email Controller. This function gives the admin user the ability to view all dynamically generated emails in a columned format. Available functions include view, edit, and remove. The edit function gives the admin user the ability to edit an outbound email's content. The view function gives the admin user the ability to view an outbound email's detail. The remove function gives the admin user the ability to remove/delete outbound emails.

The admin module may be further configured to provide an option for reviewing all inbound contact requests. Additional functions provided include: view, reply, and remove. The view function gives the admin user the ability to view the detail of an inbound contact request. The reply function gives the admin user the ability to reply to a contact request. The remove function gives the admin user the option to remove/delete an inbound contact request. A “chicken switch” may be displayed prior to the removal/deletion of any content.

The admin module may be further configured to provide admin contact history. This function gives the admin user the ability to review the history of contact between the public user and the admin user.

Feedback module 480 is configured to collect user feedback and ratings about the message portal system of the invention. The feedback module may ask a user if they wish to rate the system. If the user provides a less than optimal rating, the feedback module may generate a field that asks “What can we do better?” The field also includes Send and Cancel options. If a user clicks Cancel, no action occurs and the feedback field is closed. If a user clicks Send, and information entered is valid, the message contents may be posted to the Admin Contacts Controller with the subject “client app ratings feedback.” Admin users may be notified of client rating feedback by email. Client Rating Feedback notification email may be controlled by Admin Outbound Email Controller. If a user provides an optimal rating, such as a five star rating, the user may be asked to confirm the rating.

One of the main features of the system is gathering a user's messages in one place, regardless of where the message originated (e.g., e-mail systems, third-party social networks, message boards, blogs, microblogs, VOIP, videoconferencing sites, and media sharing websites). In a preferred embodiment of the present invention, the aggregator module further allows the user to organize their messages into various groups, based on any criteria the user deems important. For instance, a user may create a group of messages from friends and a separate group of messages from business associates. One of ordinary skill in the art would appreciate that there are numerous criteria which may be applied to organize and arrange messages, and embodiments of the present invention are contemplated for use with any such criteria.

According to an embodiment of the present invention, The aggregator module allows users to save, delete, sort, update, label, organize and otherwise change and rearrange their messages via one or more graphical user interfaces accessible via a computing device, whether mobile (e.g., smartphone, tablet PC) or stationary (e.g., desktop PC). In certain embodiments, the aggregator module may be provided as a graphical user interfaces via integration into one or more browsers or other software applications installed or otherwise utilized on a computing device of the user (e.g., plugin for a web browser).

According to an embodiment of the present invention, the aggregator module is configured to retrieve e-mail messages from POP3 and IMAP e-mail accounts. In addition, the aggregator module is configured to retrieve social media posts, blog posts, message board posts, tweets, SMS messages, MMS messages, instant messages, and text messages. Messages include text and any embedded or attached document files (e.g., DOCs, PDFs), image files, (e.g., JPGs, GIFs), media files (e.g. MP3, AVI). The retrieved messages may also include uniform resource locator (URL) data, meta data, or any other web data (e.g. HTML, XML data). One of ordinary skill in the art would appreciate that there are numerous types of message data that could be retrieved with embodiments of the present invention, and embodiments of the present invention are contemplated for use with any type of electronic message.

According to an embodiment of the present invention, the system may provide the user with the ability to organize and arrange messages as they see fit. The user may organize and arrange the messages based on any number of criteria, including, but not limited to, date/time, platform, sender, author, perceived importance, subject, size, or any combination thereof. One of ordinary skill in the art would appreciate that there are numerous types of criteria by which the system can allow the user to arrange their messages, and embodiments of the present invention are contemplated for use with any such criteria.

According to an embodiment of the present invention, the system may be configured to allow users to save messages from any source (e.g., Facebook®, Twitter®, Instagram®, Gmail®) into a central repository such as data store 400 within the system. In general, this storage is in the format of an electronic medium as previously described herein. In a preferred embodiment, the messages are linked back to the original webpage where they were created.

### Exemplary Embodiments

According to an exemplary embodiment of the present invention, the system will provide a landing portal in the application for first time users. A link, button or other interactive element will be provided on the landing page for adding social networking accounts (e.g. Facebook®, Google+™, Twitter®, LinkedIn®) and e-mail accounts (e.g. Gmail™, Outlook®) to the message portal. When the user clicks on the link, the user is taken to a social media setup web page in which they can choose one or more social media accounts to add. In a preferred embodiment, the social medial setup page is integrated with a plurality of social media APIs. When a user selects a social media site by clicking it the user is taken to the social media site where they can enter their login credentials. The system may record the user's login credentials, or the user may be given an option to save their login credentials with the system, so that the system may utilize this login information to access the account and retrieve messages. Once the login information is saved with the system, the system displays a “next” button, which indicates that the social media account was successfully linked to the system, i.e. messages from the social media account(s) will be retrieved and displayed in the message portal. Clicking the “next” button takes the user to a web page to set up their e-mail accounts.

The e-mail set up page allows a user to setup their POP3 email accounts, including but not limited to a Gmail® account. The e-mail setup page will be integrated with the POP3 e-mail program API. A user is able to link multiple POP3 email accounts. When user clicks a “done” button the email accounts are linked successfully to the message portal, i.e. messages from the e-mail account(s) will be retrieved and displayed in the message portal. The user is then taken to a “Review and Confirm” page in which a user is able to review and confirm the e-mail account settings and confirm that they wish to add the account to the message portal. A “set another” button allows a user to link another POP3 email account.

The “Review and Confirm” page allows a user to view all linked accounts. In addition, the “Review and Confirm” page may show links available to be added. Additional page functionality may include an “Add Social Media Account” button, an “Add Email Account” button and “Complete” button. When user clicks “Complete”, any user accounts linked to the message portal will be saved and the user will be taken to the message portal page, which displays all of the user's message feeds. When user clicks the “Add Social Media Account” button, the user is taken to the social media account selection page previously discussed. When a user clicks the “Add Email Account” button the user is taken to the e-mail setup page previously discussed.

Once the setup process described above is complete, the system generates a setup confirmation that notifies the user that their message feed account is active. In addition, a user will also receive instructions regarding how to update their setting at any time.

According to the exemplary embodiment described herein, the message feed portal will be the main landing page for users. The message portal will list all activity notifications for linked social media accounts and linked email accounts of the user. Incoming notifications will push down old notifications and may glow for some period of time. Notifications are displayed one line at a time and may be summarized or truncate to fit on a line. The terms “notification” and “message” shall be regarded as equivalent terms throughout this application. Each message may further be a clickable link. Clicking on a message may open the entire message and provide a response field, or may take the user to the native platform in which the message was created. In the native platform a user can use the native platform's functionality.

The message feed portal may also include an “edit” feature. When a user clicks “edit”, the user is taken to an “Edit My Feeds” view. When a user clicks a social media notification, the user is able to view activity on the respective social media site. If the user is taken to the social media page, the system will provide a link back to the main feed page. When a user clicks an email notification, the user is taken to a “send an e-mail” view, in which the user is able to respond to the email message.

The “Edit My Feeds” object allows a user to edit their message feed. A “View” function is provided which lists available settings for the feed, wherein feed settings are defined by the user. Other features include a save function, which saves the user defined feed settings. The “Edit My Feeds” object also includes a “Manage Social Networks” link and a “Manage Email Accounts” link. When a user clicks the “Manage Social Networks” link, the user is taken to an “Add/Edit/Remove Social Networks” page. When a user clicks the “Manage Email Accounts” link, the user is taken to an “Add/Edit/Remove Email Accounts” page.

The “Add/Edit/Remove Social Networks” page allows a user to add, edit, or remove social networks from the feed portal. This page may be integrated with a plurality of social media website APIs, such as Facebook®, Twitter®, LinkedIn®, and Google+®. The “Add/Edit/Remove Social Networks” page includes an “edit” function which will load a form object that displays a list of social networks accounts linked to the feed portal. The page also includes a “new” function which allows a user to add social network accounts to the feed portal. If a user selects one of the social network accounts listed in the form object the following additional functions appear: “Cancel”, “Save”, “Remove”. If a user clicks “Cancel”, no action occurs and the view closes. If a user clicks “Save”, one or more social network accounts are added to the feed portal, assuming all necessary information regarding the social network account was entered correctly. Inline Add/Edit Social Networks Confirmation view will appear without a page refresh. When a user clicks “Remove”, a confirmation message appears: “Are you sure you want to unlink social media account?” If the user clicks “Cancel” no action occurs and the view closes. If the user clicks “Confirm”, the selected social media account will be unlinked. Remove Social Network Confirmation will appear without page refresh.

The “Add/Edit/Remove Email Accounts” page allows a user to add, edit or remove email accounts from the feed portal by clicking an “add”, “edit”, or “remove” button object. Further, this page may be integrated with any POP3 email API. If a user clicks “edit” the page loads a form object displaying email accounts linked to the feed portal. The page may also include a “new” button object. Clicking the “new” button allows a user to link a new email account to the feed portal.

A user may select a linked email accounts displayed in the form object. Selecting an e-mail account generates the following options: Cancel, Save, Remove. If a user selects the “cancel” option no action occurs and the form object closes. If a user clicks the “save” option, any updates or newly submitted email accounts are added to the feed portal, assuming the necessary email account information entered is valid. An “Add/Edit Email Accounts” Confirmation appears without page refresh when new email accounts are added or changes to existing linked email accounts are made. If a user clicks the “remove” option a confirmation message will appear such as: “Are you sure you want to unlink email account?” If the user clicks the “Cancel” option no action occurs and the form view closes. If the user clicks “Confirm” the selected email account will be unlinked from the feed portal. The Remove Email Network Confirmation will appear without page refresh.

In accordance with the exemplary embodiment discussed herein, a user may respond to an email message in the message portal by clicking on the email message. Clicking an email message opens a page showing the full email message and allows a user to respond to the email. The email message/response page is integrated with a POP3 API. The email message view page displays the selected email thread. A user can read the email, and is taken to the native platform to reply to the message if the aggregator system cannot be integrated with the native platform via API. The email message page includes a textbox or response field for replying to the message. Form fields are validated using JavaScript and any errors are displayed without page refresh. Data entered in the response field may also be sanitized. The email message/response page includes a “Reply” button object. If a user clicks “Reply”, and information entered in the response field is valid, the reply message will be emailed back to the recipient. A “Sent Confirmation” also appears.

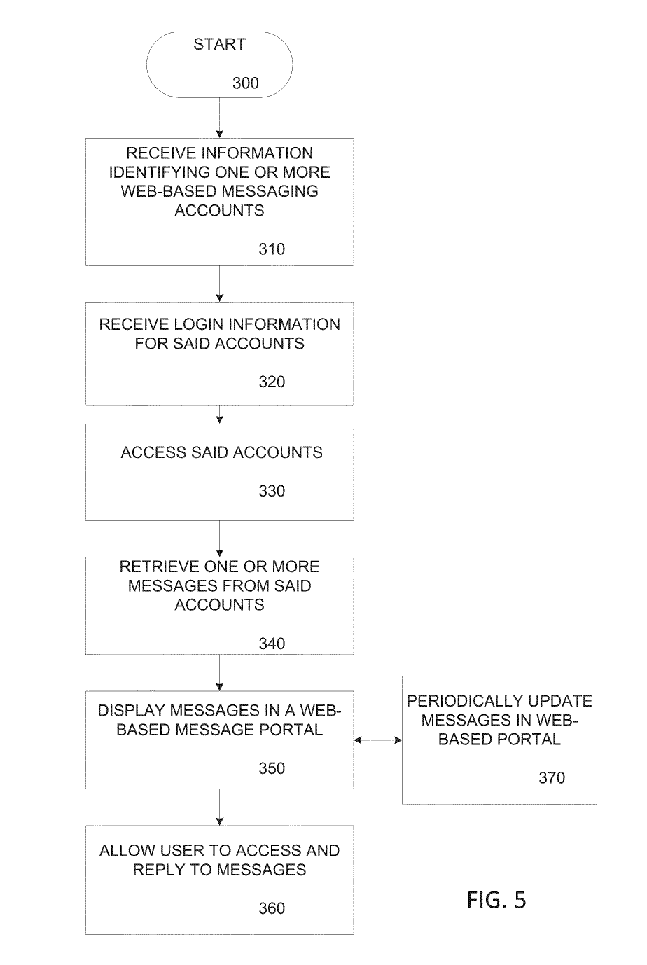

Turning now to FIG. 5, an exemplary method according to an embodiment of the present invention is shown. In this method, the process starts at step 300 with a user interacting with the system. At step 310, the system receives information identifying one or more web-based messaging accounts of a user. Web based messaging accounts may include e-mail accounts, social networking accounts, message board accounts, blog accounts, and mobile device accounts.

At step 320, the system receives login information from the user for accessing the identified accounts. At step 330, the system accesses the identified accounts and at step 340 retrieves any messages. For purposes of this application, the term “message” shall include one or more social media notifications, conversations, message threads, e-mails, text messages, instant messages, or any other electronic communications.

At step 350, the system displays messages from the user's one or more accounts in a web-based message portal. A user may configure how messages are displayed in the portal. This may be useful in helping to differentiate messages based on their source (e.g. social media, professional networking, text messages, e-mails, etc.), or some other criteria. Furthermore, the messages may be displayed in any order, but are preferably displayed with the most recent messages at the top. For example, new messages bump down older messages as they are posted in the message portal. At step 360, a user may access and reply to any message displayed in the message portal. Selecting or clicking a message opens the full message and allows the user to reply in a response field. One of ordinary skill in the art will appreciate that a response field may be used to send text, images, multimedia files, documents, or other types of files. Alternatively, a message may be a link to the native platform from which the message originated. In this case, a user is taken to the native platform upon clicking the message. The system provides a return link that may be used to return to the message portal from the native platform. At step 370, the system periodically updates messages displayed in the message portal.

According to an embodiment of the present invention, the message aggregator system allows a user to gather messages from various sources (e.g., email, IM, online social networks) into one location. The system alleviates the need to login to multiple user accounts to access and reply to messages. In addition, the system provides a simple GUI that displays incoming messages line-by-line, allowing users to quickly review all of their daily messages in one place. In addition, the system allows a user to quickly reply to a message, wherein the reply appears in the same native platform used to create the message. Messages may be displayed according to a default setting, or may be configured by the user to appear in any order, style, font, size, etc. Messages may also be organized in any useful manner, such as by source platform, sender, date/time, subject, size, importance, or some other criteria.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for providing social aggregation, the system comprising:
a processor;
a non-transitory, computer readable memory in communication with said processor;
an aggregator module comprising computer-executable code stored in said memory,
wherein said aggregator module, said processor, and said memory are communicatively connected, and said aggregator module is configured to:
receive information identifying said user's web-based messaging accounts;
receive login information from said user for each of said accounts;
access said accounts and retrieve one or more of messages from said accounts;
display said one or more messages in a web-based message portal,
wherein a user is able to respond to any of said messages by selecting it in the message portal, and
wherein said messages are periodically updated.

2. The system of claim 1, wherein said messaging accounts comprise e-mail, social media, blog, microblog, file sharing, message board, text message, instant message, live chat, VOIP, videoconferencing, and mobile device accounts.

3. The system of claim 1, further comprising a social media setup module configured to generate a social media setup web page in which a user can identify and setup one or more social media accounts from which messages can be retrieved and displayed in said message feed portal.

4. The system of claim 1, further comprising an email setup module configured to generate an email setup web page in which a user can identify and setup email accounts from which email messages can be retrieved and displayed in said message feed portal.

5. The system of claim 1, wherein said messages comprise emails, notifications, conversation threads, postings, instant messages, text messages, or any other electronic communications.

6. The system of claim 1, wherein said aggregator module is integrated with a third-party platform's API.

7. The system of claim 1, further comprising a message portal module configured to generate said message feed portal.

8. The system of claim 1, wherein said one or more messages are link objects.

9. The system of claim 8, wherein the act of clicking on one of said messages takes a user to the native platform from which the message originated.

10. The system of claim 1, further comprising an admin module configured to generate an admin portal for performing various administrative functions.

11. The system of claim 10, wherein said administrative functions include: adding new admin users, removing admin users, viewing registered users, viewing user account details, blocking access to the system, exporting messages, view incoming/outgoing messages, review inbound contact requests, and reviewing contact history.

12. The system of claim 1, further comprising a feedback module configured to collect user feedback and ratings about the web-based message portal system.

13. A computer implemented method for providing social aggregation, said method comprising the steps of:
receiving information identifying a user's web-based messaging accounts;
receiving login information for said accounts;
accessing said accounts;
retrieving one or more messages from said accounts;
displaying said messages in a web-based message portal,
wherein a user is able to respond to any of said messages by selected it in said message portal, and
wherein, said messages are periodically updated.

14. The method of claim 13, wherein said web-based messaging accounts include e-mail, social media, blog, microblog, file sharing, message board, text message, instant message, live chat, VOIP, videoconferencing, and mobile device accounts.

15. The method of claim 13, wherein said messages comprise emails, notifications, conversation threads, postings, instant messages, text messages, or any other electronic communications.

16. The method of claim 13, wherein said one or more messages are link objects.

17. The method of claim 16, wherein the act of clicking on one of said messages takes a user to the native platform from which the message originated.

18. The method of claim 13, further comprising the step of:
storing said user's messaging account information in a data store.
